(19) United States
(12) Patent Application Publication
(10) Pub. No.: US 2020/0024404 A1
(43) Pub. Date: Jan. 23, 2020

(54) SEALING MEMBER AND WATERPROOF CONNECTOR

(71) Applicants: AutoNetworks Technologies, Ltd., Mie (JP); Sumitomo Wiring Systems, Ltd., Mie (JP); Sumitomo Electric Industries, Ltd., Osaka (JP)

(72) Inventor: Takaaki Hamaguchi, Mie (JP)

(21) Appl. No.: 16/495,262

(22) PCT Filed: Mar. 16, 2018
(86) PCT No.: PCT/JP2018/010413

§ 371 Date: Sep. 18, 2019

(30) Foreign Application Priority Data
Mar. 23, 2017 (JP) 2017-057718

(51) Int. Cl. C08G 77/12; C08G 77/20; C08L 83/04; H01R 13/52

(52) U.S. Cl. CPC C08G 77/12; C08G 77/20; C08L 83/04; C08L 2205/05; C08L 2312/00; C08L 2203/20; H01R 13/5216

(57) ABSTRACT

The present invention provides a sealing member (1) configured such that the occurrence of tearing therein can be suppressed and a waterproof connector (2) having favorable waterproofness. The sealing member (1) is formed of a thermosetting silicone rubber that contains, in its molecules; a first unit derived from a first silicone compound that has at least two vinyl groups per molecule; a second unit derived from a second silicone compound that has at least two hydrosilyl groups per molecule; and a third unit derived from an organic compound that has at least two vinyl groups per molecule and is different from the first silicone compound. The waterproof connector (2) includes the sealing member 1.

### TECHNICAL FIELD

The present invention relates to a sealing member and a waterproof connector.

### BACKGROUND

Conventionally, in the field pertaining to connectors used for connecting a wire harness for vehicles such as automobiles, a waterproof connector provided with a sealing member has been used in order to suppress the intrusion of water into the connector (see Patent Document 1 etc.). Typically, the sealing member has an insertion hole into which a terminal-equipped electric wire having a terminal connected to an end portion thereof is to be inserted. In the waterproof connector, when the terminal-equipped electric wire is inserted into the insertion hole, the inner surface of the insertion hole comes into close contact with the outer peripheral surface of the electric wire, whereby the intrusion of water into the connector is suppressed.

### PRIOR ART DOCUMENT

### Patent Document

Patent Document 1: JP 2016-58138A

### SUMMARY OF THE INVENTION

### Problems to be Solved

Recent years have seen demand for downsizing of a waterproof connector, as well as an increase in the number of electric wires to be insertedthereto (the number of poles). Under these circumstances, sealing membersare being provided with a plurality of insertion holes while the diameter of the insertion holes is being made smaller.

However, in such a sealing member, as terminal-equipped electric wires are inserted into respective insertion holes, the sealing member, which is flexible, is elastically deformed, which causes shrinkage of the diameters of the insertion holes into which terminal-equipped electric wires have not yet been inserted. Accordingly, during the insertion of the terminal-equipped electric wires into these insertion holes, the inner surfaces of the insertion holes may be torn by terminals made of metal, which results in deterioration of the waterproofness of the waterproof connector.

The present invention was made in view of the above-described background, and an object of the present invention is to provide a sealing member configured such that the occurrence of tearing therein can be suppressed, and a waterproof connector having favorable waterproofness.

### Means to Solve the Problem

One aspect of the present invention lies in a sealing member formed of a thermosetting silicone rubber. The thermosetting silicone rubber contains, in its molecules:a first unit derived from a first silicone compound that has at least two vinyl groups per molecule;a second unit derived from a second silicone compound that has at least two hydrosilyl groups per molecule; and a third unit derived from an organic compound that has at least two vinyl groups per molecule and is different from the first silicone compound.

Another aspect of the present invention lies in a waterproof connector including the above-described sealing member.

### Effect of the Invention

The thermosetting silicone rubber used to form the above-described sealing member has, in its molecules,the third unit in addition to the above-described first unit and the second unit. Thus, due to the presence of the third unit, the thermosetting silicone rubber used to form the sealing member can have a larger molecular weight between crosslinks than thermosetting silicone rubbers composed only of the first unit and the second unit. Thus, due to the increase in molecular weight between crosslinks, the thermosetting silicone rubber used to form the sealing member exhibits a reduced modulus at break and an increased elongation at break. Therefore, according to the sealing member, the stress applied to the insertion holes during insertion of terminal-equipped electric wires into the insertion holes is reduced, whereby tearing of the insertion holes can be suppressed. Moreover, according to the sealing member, even if tearing occurs, the tearing is unlikely to worsen.

The waterproof connector includes the sealing member. Accordingly, the waterproof connector can exhibit favorable waterproofness.

### BRIEF DESCRIPTION OF THE DRAWINGS

FIG. 1 is a cross-sectional view schematically illustrating a sealing member and a waterproof connector (in part) of Example 1, taken along line I-I.

FIG. 2 is a schematic view illustrating the sealing member and the waterproof connector (in part) of Example 1, as viewed from the rear side thereof.

### DETAILED DESCRIPTION OF EXECUTE THE INVENTION

In the sealing member described above, the first unit in the thermosetting silicone rubber is a moiety derived from a first silicone compound having at least two vinyl groups per molecule. Examples of the first silicone compound include dimethylpolysiloxane with dimethylvinylsiloxy groups added to both ends of the molecular chain and dimethylpolysiloxane-methylvinylsiloxane copolymers with dimethylvinylsiloxy groups added to both ends of the molecular chain. One of these first silicone compounds may be used, or two or more may be used in combination.

The second unit in the thermosetting silicone rubber is a moiety derived from a second silicone compound having at least two hydrosilyl groups per molecule. Examples of the second silicone compound include dimethylpolysiloxane with dimethylhydrogensiloxy groups added to both ends of the molecular chain and methylhydrogenpolysiloxane with trimethylsiloxy groups added to both ends of the molecular chain. One of these second silicone compounds may be used, or two or more may be used in combination.

The third unit in the thermosetting silicone rubber is a moiety derived from an organic compound having at least two vinyl groups per molecule. However, if the organic compound is the same as the first silicone compound, only the first unit and the second unit are present in the molecules of the thermosetting silicone rubber. Accordingly, the organic compound from which the third unit is derived is set to be different from the first silicone compound. Examples of the organic compound include hydrocarbons having vinyl groups at both ends of the molecular chain. One of these organic compounds may be used, or two or more may be used in combination.

The carbon number of the organic compound may be set to be not less than 8 and not more than 18. According to this configuration, the modulus at break and the elongation at break of the thermosetting silicone rubber are well balanced, and accordingly, a sealing member in which the occurrence of tearing can be more easily suppressed can be provided. Organic compounds having a carbon number of less than 8 are likely to incuran increase in material costs. On the other hand,it is difficult to obtain organic compounds having a carbon number of more than 18. Also from these perspectives, it is advantageous to use an organic compound having a carbon number of not less than 8 and not more than 18. It is to be noted that the carbon number of the organic compound in the above context encompasses the number of carbon atoms in the vinyl groups.

More specific examples of the organic compound include organic compounds represented by the following formula 1. In the formula 1, n is an integer of not less than 4 and not more than 14.

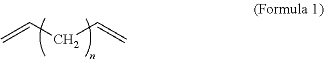

Specifically, the thermosetting silicone rubber may have a molecular structure in which the third unit is present between the first unit and the second unit. According to this configuration, a cross-linked structure in which the first unit and the second unit are crosslinked by the third unit can be easily formed, and this facilitates an increase in the molecular weight between crosslinks of the thermosetting silicone rubber. Therefore, according to the above configuration, it is possible to ensure a reduction in modulus at break and an increase in elongation at break in the thermosetting silicone rubber, and thus, the above-described actions and effects can be reliably obtained.

The thermosetting silicone rubber may contain one or more types of various known additives such as, for example, catalysts, oils, fillers, flame retardants, colorants, antioxidants, and plasticizers.

Specifically, the thermosetting silicone rubber may be composed of, for example, a thermally cured product of a silicone composition that contains 0.01 to 10 parts by mass, and preferably 0.5 to 10 parts by mass of the organic compound, with respect to 100 parts by mass of the total amount of the first silicone compound and the second silicone compound. According to this configuration, the sealing member that exhibits the above-described actions and effects can be reliably obtained. The mass ratio between the first silicone compound and the second silicone compound can be selected preferably from the range between 70:30 and 30:70 inclusive,and more preferably from the range between 60:40 and 40:60 inclusive.

The modulus at break of the thermosetting silicone rubber may be set to 14 MPa or less. According to this configuration, a sealing member that exhibits the above-described actions and effects can be reliably obtained. The modulus at break of the thermosetting silicone rubber may be set to preferably 13.8 MPa or less and more preferably 13 MPa or less, from the viewpoint of reliably suppressing the occurrence of tearing caused by terminals. Also, the modulus at break of the thermosetting silicone rubber may be set to preferably 4 MPa or more, more preferably 4.3 MPa or more, and still more preferably 4.5 MPa or more,from the viewpoint of reliably suppressing the occurrence of tearing caused by terminals.

The modulus at break of the thermosetting silicone rubber refers to a value (unit: N/mm²=MPa) determined by, according to JIS K6251, pulling a dumbbell-shaped test piece (Dumbbell shape No. 3) made of the thermosetting silicone rubber at a tensile speed of 500 mm/min at 23° C. and dividing the tensile force at the time when the test piece is broken by the initial cross-sectional area of the test piece.

The elongation at break of the thermosetting silicone rubber may be set to more than 550% and not more than 1000%. According to this configuration, a sealing member that exhibits the above-described actions and effects can be reliably obtained.

The elongation at break of the thermosetting silicone rubber may be set to preferably 560% or more, more preferably 570% or more, still more preferably 580% or more, and yet more preferably 590% or more from the viewpoint of reliably suppressing the occurrence of tearing caused by terminals. Also, the elongation at break of the thermosetting silicone rubber may be set to preferably 950% or less, more preferably 900% or less, and still more preferably 860% or less from the viewpoint of reliably suppressing the occurrence of tearing caused by terminals.

The elongation at break of the thermosetting silicone rubber refers to an elongation of a dumbbell-shaped test piece (Dumbbell shape No. 3) made of the thermosetting silicone rubber at the time when the test piece is broken after being pulled at a tensile speed of 500 mm/min at 23° C. according to JIS K6251.

The sealing member may have one insertion hole into which a terminal-equipped electric wire having a terminal connected to an end portion thereof is to be inserted, or may have a plurality of such insertion holes. According to the latter configuration, as terminal-equipped electric wires are inserted into the respective insertion holes, the sealing member is elastically deformed, which causes shrinkage of the diameters of the insertion holes into which terminal-equipped electric wires have not yet been inserted. However, in the sealing member, even when the terminal-equipped electric wires are inserted into the insertion holes, tearing of the inner surfaces of the insertion holes is unlikely to occur. Specifically, the sealing member may have a shape such as a plate-like shape, a mat-like shape, or the like.

Specifically, the sealing member can be suitably used for waterproofing a waterproof connector to be used in a wire harness for a vehicle such as an automobile.

The above-described respective configurations can be used in any combination as necessary in order to obtain, for example, each of the above-described actions, effects,and the like.

### EXAMPLES

Sealing members and waterproof connectors according to examples will be described below with reference to the drawings.

### Example 1

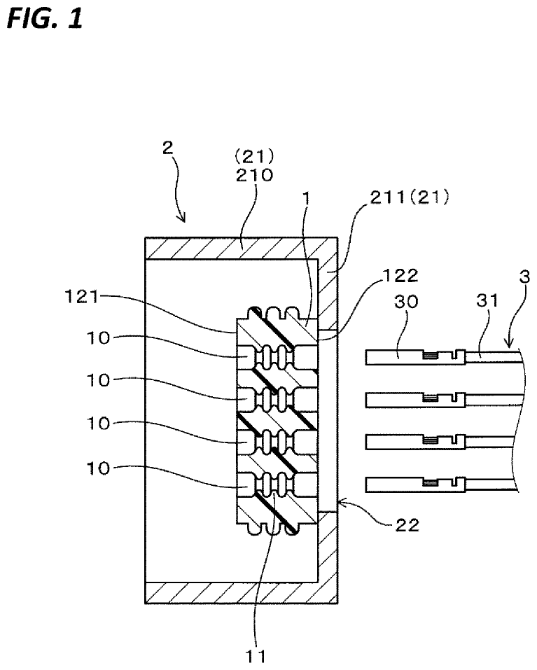

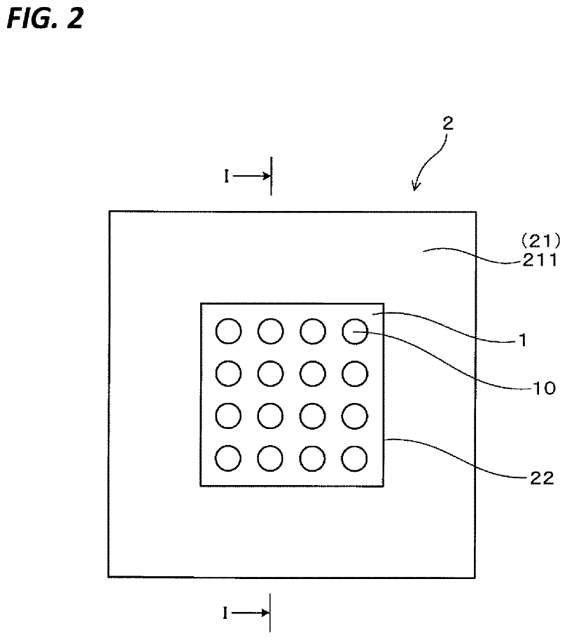

A sealing member and a waterproof connector according to Example 1 will be described with reference to FIGS. 1 and 2. As shown in FIGS. 1 and 2, a sealing member 1 of the present example is formed of a thermosetting silicone rubber that contains, in its molecules: a first unit derived from a first silicone compound that has at least two vinyl groups per molecule; a second unit derived from a second silicone compound that has at least two hydrosilyl groups per molecule; and a third unit derived from an organic compound that has at least two vinyl groups per molecule and is different from the first silicone compound.

In the present example, the sealing member 1 is formed in a square shape with a front end face 121 and a rear end face 122 extending substantially parallel to each other, and has a plurality of insertion holes 10 into which terminal-equipped electric wires 3 having terminals 30 connected to end portions thereof are to be inserted. The side where the terminals mate with mating connectors (not shown) is considered to be the front side. The inner peripheral surfaces of the insertion holes 10 are provided with annular lip portions 11 configured to achieve close contact with the outer peripheral surfaces of the electric wires 31 of the terminal-equipped electric wires 3. The plurality of lip portions 11 are provided at a predetermined interval on the inner peripheral surface of each insertion hole 10 along the insertion direction. According to this configuration, the terminal-equipped electric wires 3 inserted into the insertion holes 10 move forward inside the insertion holes 10 while the terminals 30 expand the insertion holes 10. After the terminals 30 have come out from the insertion holes 10, the lip portions 11 come into close contact with the outer peripheral surfaces of the electric wires 31 located rearward of the terminal connection portions. As a result, gaps between the respective insertion holes 10 of the sealing member 1 and the respective electric wires 31 are collectively sealed.

Specifically, a waterproof connector 2 includes an outer housing 21 made of a synthetic resin, an inner housing made of a synthetic resin, and the above-described sealing member 1. In FIGS. 1 and 2, the inner housing is not shown. The inner housing has terminal receiving chambers, and the number of terminal receiving chambers is the same as the number of insertion holes 10 in the sealing member 1. Each terminal housing chamber is configured such that a terminal 30 of a terminal-equipped electric wire 3 can be housed therein from the rear end thereof. The outer housing 21 has a cylindrical hood portion 210 that extends forward and a base portion 211 for closing the rear end of the hood portion 210. The base portion 211 has an opening 22, and the terminals 30 of the terminal-equipped electric wires 3 can be housed in the terminal housing chambers provided in the inner housing via the opening 22.

The sealing member 1 functions as a waterproof rubber stopper for the waterproof connector 2, and is provided integrally on the inner surface side of the base portion 211 of the outer housing 21 so as to cover the opening 22 of the outer housing 21. The waterproof connector 2 is configured such that the rear end face of the inner housing is in close contact with the front end face 121 of the sealing member 1.

The thermosetting silicone rubber used to form the sealing member 1 of the present example has, in its molecules, a third unit in addition to a first unit and a second unit. Thus, due to the presence of the third unit, the thermosetting silicone rubber used to form the sealing member 1 of the present example can have a larger molecular weight between crosslinks than thermosetting silicone rubbers composed only of the first unit and the second unit. Thus, owing to the increase in molecular weight between crosslinks, the thermosetting silicone rubber used to form the sealing member 1 of the present example exhibits a reduced modulus at break and an increased elongation at break. Therefore, according to the sealing member 1 of the present example, the stress applied to the insertion holes 10 during insertion of the terminal-equipped electric wires 3 thereto is reduced, whereby tearing of the insertion holes 10 can be suppressed. Moreover, according to the sealing member 1 of the present example, even if tearing occurs, the tearing is unlikely to worsen.

The waterproof connector 2 of the present example has the sealing member 1 of the present example. Accordingly, the waterproof connector 2 of the present example can exhibit high waterproofness.

### Experimental Examples

The sealing member and the waterproof connector will be described in more detail with reference to experimental examples.

—Preparation of Materials—

As uncured thermosetting silicone rubbers, 7-6830 manufactured by Dow Corning Toray Co., Ltd. was prepared. The prepared silicone rubbers 7-6830 were all composed of two components, namely, a component A acting as a base resin and a component B acting as a curing agent. The component A contains a silicone compound having at least two vinyl groups per molecule. The component B contains a silicone compound having at least two hydrosilyl groups per molecule.

Also, as organic compounds having at least two vinyl groups per molecule, an organic compound represented by the above formula 1 where n=4 (hereinafter referred to as “C8 organic compound”), an organic compound represented by the above formula 1 where n=8 (hereinafter referred to as “C12 organic compound”), and an organic compound represented by the above formula 1 where n=14 (hereinafter referred to as “C18 organic compound”) were prepared.

—Preparation of Samples for Sealing Members—

The component A and the component B of 7-6830 were mixed together at a mass ratio of 50:50. To 100 parts by mass of the resultant mixtures, predetermined parts by mass of the predetermined organic compounds shown in Tables 1 to 3 were added. The thus-obtained respective mixtures were subjected to heating and curing by injecting them into molds that had been heated to 180° C., using an injection molding machine. Thereafter, the thus-obtained thermally cured products were cooled and removed from the mold. Through the process described above, sealing members formed of respective samples were obtained. The sealing members formed of the respective samples were each constituted by two types of members, namely, a plate-like body of 200 mm long×200 mm wide×2 mm thick and a mat-like rubber stopper (36 poles) having 36 insertion holes in total, which were arranged in 6 rows×6 columns The sample 1C did not contain any of the organic compounds.

—Measurement of Modulus at Break and Elongation at Break of Thermosetting Silicone Rubbers—

A dumbbell-shaped test piece (No. 3 type) was punched out from each of the above produced plate-like bodies. Then, using these dumbbell-shaped test pieces, the modulus at break and the elongation at break of each of the thermosetting silicone rubbers were measured according to the methods described above.

—Waterproof Test—

Each of the above produced rubber stoppers was integrally attached to an inner side surface of a base portion of an outer housing so as to cover the opening of the outer housing, and terminal-equipped electric wires were inserted into respective insertion holes. Next, the assembled connector was attached to one end of a tube, thereby providing a test body. Then, the other end of the tube was made to allow supply of air to the test body there from. Also, the test body was immersed in water in a horizontal state, and the terminal-equipped electric wires were pulled upward while keeping the insertion holes horizontal. Subsequently, air was supplied at 200 kPa from the other end of the tube, and the occurrence of an air leak at positions between the rubber stopper and the electric wires was checked for. In a case where the generation of air bubbles resulting from an air leak was not observed for 10 seconds, the test body was evaluated as having an excellent waterproofness and was indicated with “⊚ (double circle)”. In a case where the generation of air bubbles resulting from an air leak was not observed for 10 seconds but was observed before 30 seconds had elapsed, the test body was evaluated as having good waterproofness and was indicated with “∘ (circle)”. In a case where the generation of air bubbles resulting from an air leak was observed within 10 seconds after the start of the air leak test and the presence of a tear caused by the terminals was observed on the inner surfaces of the insertion holes after the above test, the test body was evaluated as having insufficient waterproofness and was indicated with “x (cross)”.

The detailed configurations of the sealing members, the measurement results, and the test results are all shown in Tables 1 to 3.

TABLE 1

| | | Sample | | | | | |
|---|---|---|---|---|---|---|---|
| | | 1C | 1 | 2 | 3 | 4 | 5 |
| Types of | C8 organic | — | 0.5 | 1 | 3 | 5 | 10 |
| organic | compound | | | | | | |
| compounds | C12 organic | — | — | — | — | — | — |
| used in | compound | | | | | | |
| production | C18 organic | — | — | — | — | — | — |
| of sealing | compound | | | | | | |
| member and | | | | | | | |
| the number of | | | | | | | |
| parts added | | | | | | | |
| (parts by | | | | | | | |
| mass) | | | | | | | |

| | | | | | | |
|---|---|---|---|---|---|---|
| Modulus at Break (MPa) | 15.8 | 10.8 | 9.2 | 7.9 | 6.8 | 4.3 |
| Elongation at Break (%) | 510 | 630 | 650 | 750 | 790 | 860 |
| Waterproof Test (Whether | X | ⊚ | ⊚ | ⊚ | ⊚ | ◯ |
| air leak occurred at 200 kPa) | | | | | | |

TABLE 2

| | | Sample | | | | |
|---|---|---|---|---|---|---|
| | | 6 | 7 | 8 | 9 | 10 |
| Types of organic | C8 organic | — | — | — | — | — |
| compounds used in | compound | | | | | |
| production of sealing | C12 organic | 0.5 | 1 | 3 | 5 | 10 |
| member and the | compound | | | | | |
| number of parts | C18 organic | — | — | — | — | — |
| added (parts by mass) | compound | | | | | |

| | | | | | |
|---|---|---|---|---|---|
| Modulus at Break (MPa) | 11.2 | 10.5 | 9 | 7.2 | 5.8 |
| Elongation at Break (%) | 600 | 640 | 730 | 780 | 810 |
| Waterproof Test (Whether air | ⊚ | ⊚ | ⊚ | ⊚ | ⊚ |
| leak occurred at 200 kPa) | | | | | |

TABLE 3

| | | Sample | | | | |
|---|---|---|---|---|---|---|
| | | 11 | 12 | 13 | 14 | 15 |
| Types of organic | C8 organic | — | — | — | — | — |
| compounds used in | compound | | | | | |
| production of sealing | C12 organic | — | — | — | — | — |
| member and the | compound | | | | | |
| number of parts added | C18 organic | 0.5 | 1 | 3 | 5 | 10 |
| (parts by mass) | compound | | | | | |

| | | | | | |
|---|---|---|---|---|---|
| Modulus at Break (MPa) | 13.8 | 10.9 | 9.2 | 8.1 | 6.2 |
| Elongation at Break (%) | 550 | 590 | 610 | 690 | 790 |
| Waterproof Test (Whether | ◯ | ⊚ | ⊚ | ⊚ | ⊚ |
| air leak occurred at 200 kPa) | | | | | |

The following can be seen from Tables 1 to 3. The rubber stopper of the sample 1C was obtained by mixing the two components, namely, the component A acting as a base resin and the component B acting as a curing agent, and then thermally curing the resultant mixture. That is, the rubber stopper of the sample 1C was formed of a thermosetting silicone rubber having a unit derived from the component A and a unit derived from the component B in its molecules, and the thermosetting silicone rubber did not contain a unit derived from an organic compound having at least two vinyl groups per molecule. Accordingly, in the waterproof connector of the sample 1C in which the rubber stopper of the sample 1C was used, tearing occurred on the inner surfaces of the insertion holes during the insertion of the terminal-equipped electric wires, and this caused an air leak.

In contrast, the rubber stoppers of the samples 1 to 15 were each obtained by adding,to a mixture of the component A acting as a base resin and the component B acting as a curing agent, a predetermined organic compound having at least two vinyl groups per molecule and then thermally curing the resultant mixture containing this organic compound. In other words, the rubber stoppers of the samples 1 1 to 15 were formed of the thermosetting silicone rubbers having the above-defined first unit, second unit, and third unit in its molecules.

Accordingly, in the rubber stoppers of the samples 1 to 15, the molecular weights between crosslinks were higher than that in the rubber stopper of the sample 1C, and thus, the rubber stoppers of the samples 1 to 15 exhibited a reduced modulus at break and an increased elongation at break. As a result, the stress applied to the insertion holes during the insertion of the terminal-equipped electric wires thereto was reduced, whereby tearing of the insertion holes could be suppressed. As a result, the rubber stoppers of the samples 1 to 15 could satisfy the waterproofness in the above-described waterproof test.

Although the example and the experimental examples of the present invention have been described in detail above, the present invention is not limited to the above-described example and experimental examples, and may be modified in various ways without departing from the spirit and scope of the present invention.

1. A sealing member formed of a thermosetting silicone rubber, the thermosetting silicone rubber comprising, in its molecules:
a first unit derived from a first silicone compound that has at least two vinyl groups per molecule;
a second unit derived from a second silicone compound that has at least two hydrosilyl groups per molecule; and
a third unit derived from an organic compound that has at least two vinyl groups per molecule and is different from the first silicone compound.

2. The sealing member according to claim 1,
wherein the organic compound has a carbon number of not less than 8 and not more than 18.

3. The sealing member according to claim 1,
wherein the thermosetting silicone rubber has a modulus at break of 14 MPa or less.

4. The sealing member according to claim 1, wherein
the thermosetting silicone rubber has an elongation at break of more than 550% and not more than 1000%.

5. The sealing member according to claim 1,
wherein the thermosetting silicone rubber is composed of a thermally cured product of a silicone composition that contains 0.01 to 10 parts by mass of the organic compound with respect to 100 parts by mass of a total amount of the first silicone compound and the second silicone compound.

6. The sealing member according to claim 1,
wherein the sealing member has a plurality of insertion holes into which terminal-equipped electric wires each having a terminal connected to an end portion thereof are to be inserted.

7. A waterproof connector comprising:
the sealing member according to claim 1.
